(19) United States
(12) Patent Application Publication
(10) Pub. No.: US 2006/0261153 A1
(43) Pub. Date: Nov. 23, 2006

(54) Automated payment system with additional capability

(76) Inventor: Terry McLoughlin, Toronto (CA)

Correspondence Address: Dennison Associates, Suite 301, 133 Richmond Street West, Toronto, M5H 2L7, CA

(21) Appl. No.: 11/433,498

(22) Filed: May 15, 2006

(30) Foreign Application Priority Data
May 20, 2005 (CA) 2,508,083

(51) Int. Cl. G07F 19/00

(52) U.S. Cl. 235/379

(57) ABSTRACT

An automated payment accommodates the provision of additional services being offered at the time of settling a transaction. The system can track the offer of additional services and whether such services were arranged. The system at a later date can reproduce the various steps as part of an audit function. The automated system has particular application with respect to arranging for taxi services.

### FIELD OF THE INVENTION

The present invention relates to additional services associated with automated payment systems.

### BACKGROUND OF THE INVENTION

Automated payment systems for completing transactions by debit or credit cards are well known. With respect to debit cards and as now suggested for credit cards, the user must enter a PIN number as part of the authorization process. Various techniques are used to encrypt the information such that the PIN number remains confidential.

A problem associated with debit cards in a traditional restaurant type environment is the convenient entry of the PIN number. As can be appreciated, the mere swiping of the debit card and then providing a receipt at a restaurant table is not sufficient. For this reason, wireless payment terminals are used where a terminal is provided to the user at a table where the debit card is swiped and the user completes the transaction and enters the proper authorization PIN. These terminals are also known to include a printer to allow printing of a transaction receipt. Such wireless payment terminals have particular application for restaurant environments but can also be used for other applications.

With automated payment systems the card information is determined and associated with the particular sales information and merchant information. This information is then communicated to a remote financial institution such as a bank. The bank then reviews the transaction and provides an authorization code if the transaction is deemed to be acceptable. All of these steps occur in real time.

The present invention recognizes that wireless terminals can be additionally used to provide further services or optional services to the user in a convenient manner.

An automated payment system according to the present invention comprises a series of wireless remote terminals communicating with a base station. The base station is in communication over a network with at least one remote financial service provider for processing of financial transaction. The series of wireless remote terminals include a card reader for reading of card information and communicating the information through the base station to a remote financial service provider. The base station additionally is in communication with non financial service providers and presents to the cardholder after reading of the card information with respect to an option for additional services to be provided by one of the non financial providers. The base station forwards any requests by the cardholder and provides at least some of the card information to one of the non financial service providers to be used in completing the additional request for services.

### SUMMARY OF THE INVENTION

According to an aspect of the invention one of the non financial service providers includes a taxi service provider.

In yet a further aspect of the invention the automated payment system includes an audit function that tracks additional services offered to the cardholder at the time of settling a transaction and whether such services were implemented or declined.

In yet a further aspect of the invention the system includes a manager override function necessary to override a recommended service to be provided by one of the non financial service providers.

In a different aspect of the invention the system uses the card information to provide improved services with respect to completing a valet service.

In yet a different aspect of the invention the non service provider is a further establishment for completing an additional activity. Such an additional activity could include confirmation of a reservation at a further establishment.

### BRIEF DESCRIPTION OF THE DRAWINGS

Preferred embodiments of the invention are shown in the drawings, wherein:

FIG. 1 is an overview of the automated payment system for use in association with a taxi service;

FIG. 2 is the depiction of a terminal screen seeking additional information from the cardholder;

FIG. 3 is a screen similar to FIG. 2 for a different service;

FIG. 4 is a schematic showing the combining of card information and merchant information for providing of a further service; and

FIG. 5 is a depiction of a transaction receipt in combination with a coupon or reservation confirmation.

### DETAILED DESCRIPTION OF THE PREFERRED EMBODIMENTS

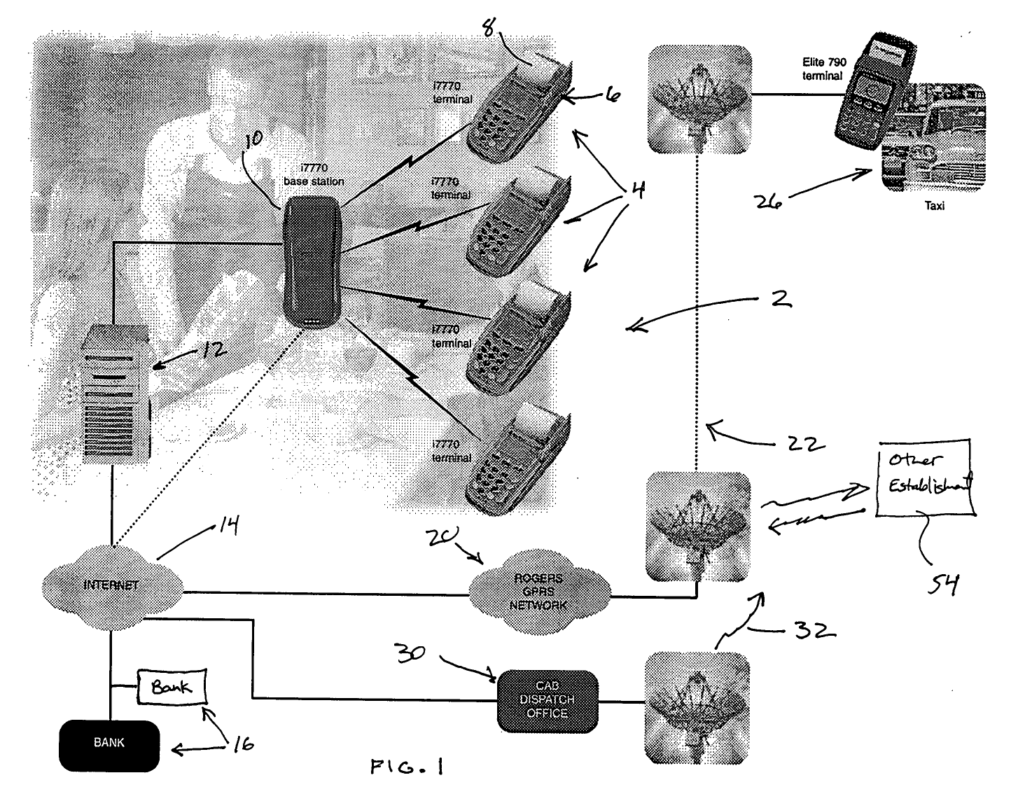

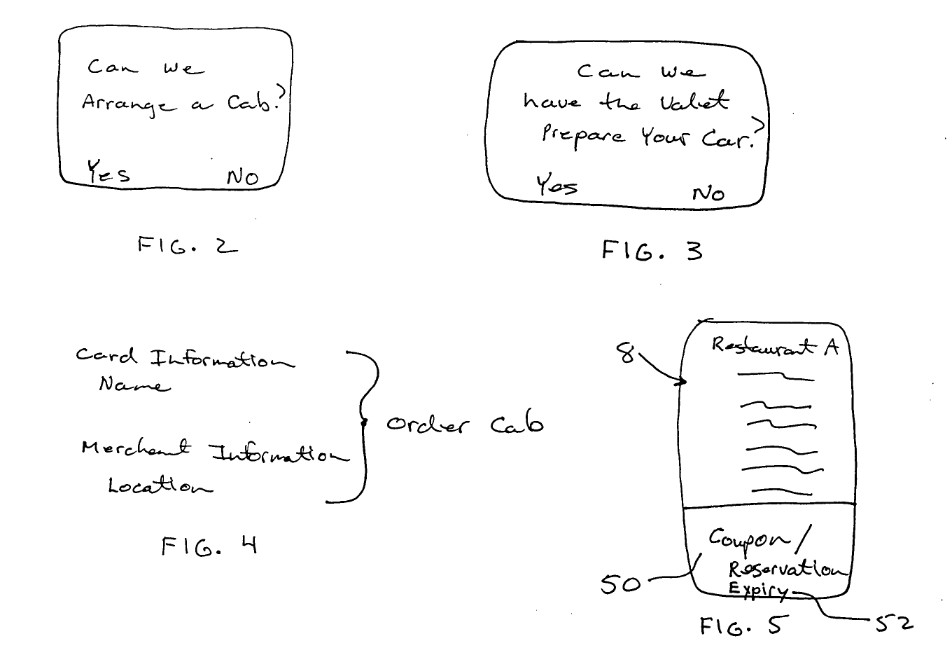

The automated payment system 2 shown in FIG. 1 includes a series of wireless terminals 4 in communication with the base station 10. This base station is typically hardwired to a payment system server 12 which in turn is in communication with the INTERNET shown as 14. In this way, the particular establishment having the wireless terminals 4, can communicate with other providers through the communication channels including the INTERNET for example. In this case, the payment system server 12 can be in communication with a wireless Pes network e.g. ROGERS GPRS Network 20 or a cab dispatch office indicated as 30. Other non financial service providers can also be included.

As part of the normal automated payment system the payment server 12 is in communication with a series of financial transaction providers indicated as 16. These are typically banks, credit card companies, etc. and operate in a normal manner.

For many restaurant establishments and/or bars, it may be valuable to offer the particular client or cardholder, at the time of completing the transaction, an additional service. One such service is the possibility of arranging for a taxi. In the schematic of FIG. 1, such a taxi service is shown as 26. In certain circumstances it is, for the establishment, important to be able to provide confirmation of the activities of the establishment including the ability of the establishment to confirm that additional services are recommended.

For example, if the establishment recommends that a client not drive, it may be valuable to be able to prove that the establishment recommended and sought to arrange suitable transportation including the provision of a taxi. In order to accomplish this, the card member or a member of a party at the time of completing a transaction after he has swiped his card at one of the wireless terminals 4, is presented with a screen such as shown in FIG. 2 where the establishment offers to arrange for a cab. The automated payment system already includes the cardholder's name as well as the merchant's location and can provide this information through the INTERNET 4 to the cab dispatch office 30 or to a related service, in this case shown as the ROGERS GPRS Network. This related service is a broadcast based system of wireless terminals provided in taxis. This allows the user of the taxi to pay for the taxi using credit or debit card using the wireless terminal 4. The offer of the cab service as well as the cardholder's decision with respect to the cab services are maintained as part of an audit trail by the payment terminal (4) 70.

The wireless terminals 4 include a printer 6 for printing of a receipt generally indicated as 8. This receipt can also include a copy of the cardholder's decision with respect to these services.

One of the advantages of the system is that the automated payment system effectively arranges for this service to be provided without additional information. Basically a cab will arrive at the location of the merchant and will pick up the particular cardholder or a member of his party. Obviously the taxi will be seeking the patron having the name of the cardholder.

With the system of FIG. 1, the automated payment system 2 for use in association with a restaurant, has been combined with a similar automated payment system provided for taxicabs. Thus it is possible to have these automated payment systems interact with each other for providing of additional services.

A different embodiment of the invention is shown in FIG. 3 where the terminal display asks whether the establishment can arrange for the valet to provide the cardholder's automobile. In this way, the valet service can be automated as part of the payment system for providing better service to the patron.

FIG. 1 also shows a further use of the system where as part of the settlement of the transaction the wireless terminal 4 can include a series of possible options that the cardholder could exercise. These options could include reservations at related establishments that the cardholder would like to proceed to. Such other establishments 54 can be in communication with the present establishment through the network and thus the ability to accept a further reservation can be continuously updated.

As part of the transaction receipt as shown in FIG. 5, the lower portion of the receipt 8 can include a coupon or reservation area 50. For example, this lower area could be confirmation of a reservation at a different establishment that has been confirmed and this reservation could also include an expiry date or time indicated as 52. Thus the automated payment system could be used for completing additional services that may be of interest to the patron. Obviously the cardholder can decline any of these options and these options can vary with the capability of the related establishments to accommodate such requests. Typically the payment terminal (4) 10 will include information with respect to the number of people in the party as well as the cardholder information and thus the additional reservations are possible.

Automated payment systems for individual establishments require the communication to the individual financial institutions generally shown as 16. It is recognized in the present application that such establishments can also be in communication with further service providers for promoting of additional services. The system provides a simple means for providing these additional services as well as updating of the capability to provide such services on an ongoing basis. Thus, options that are presented have a high probability of being fulfilled.

The automated payment system also allows for tracking of additional services provided and can be used for appropriate compensation.

The payment terminal (4) may be wireless or connected directory to the network. Typically, these terminals retain all transaction information which is downloaded to a different system on a predetermined basis.

Although various preferred embodiments of the present invention have been described herein in detail, it will be appreciated by those skilled in the art that variations may be made thereto without departing from the spirit of the invention or the scope of the appended claims.

The embodiments of the invention in which an exclusive property or privilege is claimed are defined as follows:

1. An automated payment system comprising a series of wireless remote terminals communicating with a base station in communication over a network with remote financial service providers for processing financial transactions, said series of wireless remote terminals including a card reader for reading of information of a customers card and communicating said information to said base station, said base station additionally being in communication with non financial service providers and presenting to the cardholder after reading of said card information an option for additional services to be provided by one of said non financial providers, said base station forwarding a requested by the cardholder and providing at least some of said card information to one of said non financial service providers to be used in completing the additional requested services.

2. An automated payment system as claimed in claim 1 wherein said non financial service providers include taxi service providers.

3. An automated payment system as claimed in claim 1 or 2 wherein said system includes an audit function that tracks additional services offered to a cardholder at the time of settling a transaction.

4. An automated payment system as claimed in claim 3 wherein said system includes a manager override function necessary to override a recommended service to be provided by one of said non financial service providers.

5. An automated payment system as claimed in claim 4 including additionally using said card information to arrange for completing a valet service.

6. An automated payment system as claimed in claim 3 including automatically providing for at least some transactions an option for a taxi service to be provided for the cardholder at the point of sale location.

7. An automated payment system as claimed in claim 6 including a audit function for successfully completed transactions including recording of the option for a taxi service and whether such option was exercised by the cardholder.

8. An automated payment system as claimed in claim 7 including each wireless remote terminal includes a printer that prints a transaction receipt and provides a discount coupon for a taxi service.

9. An automated payment system as claimed in claim 8 wherein said discount coupon is for a taxi service initiated at the point of sale location.

10. An automated payment system as claimed in claim 8 wherein said discount coupon uses time information of said transaction to provide a time limited discount coupon.

11. An automated payment system as claimed in claim 10 wherein said time limited discount coupon expires within a short time period such that said taxi service is initiated shortly after completion of the sale transaction.

12. An automated payment system as claimed in claim 11 wherein said taxi service provider at least partially funds the value of the discount coupon.
